(19) United States
(12) Patent Application Publication
(10) Pub. No.: US 2017/0051665 A1
(43) Pub. Date: Feb. 23, 2017

(54) Devices, Systems and Methods for Closed Loop Energy Production

(71) Applicant: Hydrogen Engine Center, Algona, IA (US)

(72) Inventor: Ted Hollinger, Algona, IA (US)

(21) Appl. No.: 15/243,532

(22) Filed: Aug. 22, 2016

Related U.S. Application Data
(60) Provisional application No. 62/207,653, filed on Aug. 20, 2015.

(51) Int. Cl. F02B 43/10; C25B 1/04; C25B 9/00; F02B 63/04

(52) U.S. Cl. CPC F02B 43/10; F02B 63/04; C25B 1/04; C25B 9/00; F02B 2043/106

(57) ABSTRACT

The present invention relates to a hydrogen-powered genset that can be operated without any gaseous exhaust and does not require any external air or water. In particular, the closed loop utilizes a system that is fueled with hydrogen and supplied with oxygen from an electrolyzer. The system re-circulates the exhaust gas to the air intake while extracting the water from it for use in the electrolyzer.

### CROSS-REFERENCE TO RELATED APPLICATION(S)

This application claims priority from U.S. Provisional Application 62/207,653, filed Aug. 20, 2015 and entitled “Devices, Systems and Methods for Closed Loop Energy Production,” which is hereby incorporated herein by reference in its entirety under 35 U.S.C. §119(e).

### TECHNICAL FIELD

The disclosed technology relates generally to devices, systems and methods for generating electrical power.

### BACKGROUND

The need to reduce green house gas emissions is highly documented. Internal combustion engine (“ICE”) fuel/air mixture systems have been under development for over 100 years in an attempt to improve performance. Gasoline and diesel engines used complex fuels that create many byproducts. Many of these byproducts are harmful to the atmosphere.

Hydrogen internal combustion engines (“HICEs”) use a very simple fuel that can create few emissions. However, these require water for an electrolyzer, air for the engine and create exhaust. And while the carbon based emissions are eliminated, NOx emissions remain. There is a need in the art for an improved hydrogen-powered system which does not require inputs of water, oxygen and hydrogen, and does not create such emissions.

### BRIEF SUMMARY

Discussed herein are various embodiments relating to the elimination of emissions and increasing engine power, by providing a closed-loop system, or “closed loop.” In certain exemplary implementations, these embodiments will allow the generation of power by way of a hydrogen engine in oxygen and water deficient areas. Accordingly, one object of the closed loop is to provide an improved apparatus and method for eliminating the normal pollution of an internal combustion engine powered electrical generator. It is further the intention to eliminate the need for water and air to run a hydrogen powered generator.

The devices, systems and methods disclosed herein relate to a closed-loop hydrogen and oxygen energy generator system. To that end, a closed loop distributed generator system is provided having an electrolyzer, water purification system, water storage tank, hydrogen and oxygen storage tanks, artificial air system and a hydrogen-fueled genset, all of which are in closed communication with one another such that the only input and output is electricity. In certain exemplary embodiments, hydrogen and oxygen are being pressurized simultaneously. In further embodiments, a small differential across an electrolyzer membrane is being maintained to separate water into hydrogen and oxygen for use in the system. Further, in certain implementations, artificial air is being utilized in certain implementations of the system to bias the combustion such that more oxygen is provided than can be used. In exemplary implementations, the closed loop serves to provide an on-demand power supply, much like a battery, in that it stores power from the electrical input in the form of pressurized hydrogen that can be utilized on demand to power the hydrogen-powered electrical generator.

In one Example, a closed loop generator system, including: an electrolyzer including a water supply and configured to produce hydrogen and oxygen; a hydrogen tank; an oxygen tank; a closed air supply; and a genset configured to run on stored hydrogen and oxygen to convert stored hydrogen and oxygen into water fed into the water supply, where the closed loop generator system is configured so as not to produce exhaust.

Implementations may include one or more of the following features. The closed loop system further including an artificial air system in hermetic communication with the genset. The closed loop system where the artificial air system is configured to bias the genset to run lean. The closed loop system where the artificial air system is configured to bias the genset to run at an equivalence ratio of less than 0.45% The closed loop system where the closed loop generator system is fluidically and hermetically sealed. The closed loop system further including a water storage unit. The closed loop system further including a turbine in operational communication with the genset, the turbine being configured to increase system efficiency. The closed loop generator system where the electrical current generator is selected from the group including of a genset and a fuel cell. The closed loop generator system where the energy source is a renewable source of electricity. The closed loop generator system where the system is configured to time-shift energy production. The closed loop generator system where the electrical current generator is a genset configured to be powered by hydrogen and oxygen. The closed loop generator system further including an artificial air system configured to bias the genset oxygen supply. The closed loop generator system further including an oxygen injector and controller. The closed loop generator system where the water supply is in sealed hermetic and fluidic communication with the genset such that water vapor exiting the genset is fed into the electrolyzer. The closed loop generator system further including an oxygen storage tank, where: the electrolyzer and electrical current generator are configured to be independently operable, and the hydrogen storage tank and oxygen storage tank are in sealed hermetic and fluidic communication with the electrolyzer and electrical current generator so as to be configured to store hydrogen and oxygen from the electrolyzer for selective use by the electrical current generator. The method of time-shifting energy production where the water supply is in sealed hermetic and fluidic communication with the genset such that water vapor exiting the genset is the water supply. The method of time-shifting energy production further including providing a euler turbine to increase efficiency.

In one Example, a closed loop generator system, including: an electrolyzer including a water supply; a hydrogen storage tank; an energy source in operational communication with the electrolyzer and hydrogen storage tank; and an electrical current generator, where the closed loop generator system is configured to selectively operable to generate output electricity without emissions.

Implementations may include one or more of the following features. The closed loop generator system where the electrical current generator is selected from the group including of a genset and a fuel cell. The closed loop generator system where the energy source is a renewable source of electricity. The closed loop generator system where the system is configured to time-shift energy production. The closed loop generator system where the electrical current generator is a genset configured to be powered by hydrogen and oxygen. The closed loop generator system further including an artificial air system configured to bias the genset oxygen supply. The closed loop generator system further including an oxygen injector and controller. The closed loop generator system where the water supply is in sealed hermetic and fluidic communication with the genset such that water vapor exiting the genset is fed into the electrolyzer. The closed loop generator system further including an oxygen storage tank, where: the electrolyzer and electrical current generator are configured to be independently operable, and the hydrogen storage tank and oxygen storage tank are in sealed hermetic and fluidic communication with the electrolyzer and electrical current generator so as to be configured to store hydrogen and oxygen from the electrolyzer for selective use by the electrical current generator. The method of time-shifting energy production where the water supply is in sealed hermetic and fluidic communication with the genset such that water vapor exiting the genset is the water supply. The method of time-shifting energy production further including providing a euler turbine to increase efficiency.

In one Example, the closed loop generator system where renewable source of electricity is selected from the group including of solar power, wind power and hydro-electric power.

In one Example, a method of time-shifting energy production, including: providing a renewable energy source of electricity; providing a closed loop generator, the generator including: an electrolyzer including a water supply; a genset, a hydrogen storage tank in sealed fluidic and hermetic communication with the electrolyzer and genset; and an oxygen storage tank in sealed fluidic and hermetic communication with the electrolyzer and genset, where: the electrolyzer and genset are configured to be independently operable, and the hydrogen storage tank and oxygen storage tank are in sealed hermetic and fludic communication with the electrolyzer and genset so as to be configured to store hydrogen and oxygen from the electrolyzer for selective use by the genset; and supplying the hydrogen and oxygen storage tanks by selectively operating the electrolyzer by way of the renewable source of electricity.

Implementations may include one or more of the following features. The method of time-shifting energy production where the water supply is in sealed hermetic and fluidic communication with the genset such that water vapor exiting the genset is the water supply. The method of time-shifting energy production further including providing a euler turbine to increase efficiency.

Implementations of the described techniques may include hardware, a method or process, or computer software on a computer-accessible medium. Other embodiments include corresponding computer systems, apparatus, and computer programs recorded on one or more computer storage devices, each configured to perform the actions of the methods. Implementations of the described techniques may include hardware, a method or process, or computer software on a computer-accessible medium.

While multiple embodiments are disclosed, still other embodiments of the disclosure will become apparent to those skilled in the art from the following detailed description, which shows and describes illustrative embodiments of the disclosed apparatus, systems and methods. As will be realized, the disclosed apparatus, systems and methods are capable of modifications in various obvious aspects, all without departing from the spirit and scope of the disclosure. Accordingly, the drawings and detailed description are to be regarded as illustrative in nature and not restrictive.

These and other objects will become apparent to those skilled in the art upon reference to the following specification, drawings, and claims.

### BRIEF DESCRIPTION OF THE DRAWINGS

FIG. 1A shows an exemplary schematic of a prior art closed loop apparatus.

FIG. 1B is a schematic view of another closed loop apparatus, according to an exemplary embodiment.

FIG. 1C is a schematic view of another closed loop apparatus, according to an exemplary embodiment.

FIG. 2A shows a closed-loop generator system, according to an exemplary embodiment.

FIG. 2B shows a schematic of a closed-loop generator system, according to an exemplary embodiment.

FIG. 3 is a schematic view of an exemplary embodiment of the control of oxygen flow in certain embodiments of the closed loop.

FIG. 4 is a schematic view of the flow of hydrogen, oxygen and artificial air through the closed loop, according to an exemplary embodiment.

FIG. 5A depicts the relationship between equivalence ratio and horsepower.

FIG. 5B is another graph depicting relationship between equivalence ratio and horsepower.

FIG. 6 depicts an alternative embodiment of the closed loop utilizing a fuel cell.

FIG. 7 is a schematic view of the flow of hydrogen, oxygen and artificial air through the closed loop, according to an exemplary embodiment.

FIG. 8 is a schematic view of the flow of hydrogen, oxygen and artificial air through the closed loop, according to an exemplary embodiment.

FIG. 9 is a schematic view of the flow of hydrogen, oxygen and artificial air through the closed loop, according to an exemplary embodiment.

FIG. 10 is a schematic view of the flow of hydrogen, oxygen and artificial air through the closed loop, according to an exemplary embodiment.

### DETAILED DESCRIPTION

Exemplary embodiments of the closed loop system disclosed herein allow for the production and storage of hydrogen and oxygen. In certain implementations, the system can function without the need for gas compressors. The closed loop can thus eliminate the need for intake air by combining the oxygen with a re-circulating exhaust gas and provide an energy storage system for use worldwide. In various implementations, the disclosed closed loop system can also condense the water formed by the exhaust produced by hydrogen-fueled combustion and re-circulate it for reuse, thereby eliminating the need for continual water input. Because all, or virtually all, exhaust gas is re-circulated in the various embodiments, there cannot be any significant exhaust gas emissions. Finally, in certain implementations, the closed loop system makes use of an artificial air system to eliminate nitrogen from the system.

It is understood that these implementations provide devices, systems and methods for the storage of energy as hydrogen for “time of use” needs, for example when natural energy sources such as solar, hydro-electric, wind and the like are unavailable. In various exemplary implementations, solar power can be used to provide energy to a building, such as a house, during daylight hours. However, during the night hours, this energy source becomes unavailable. By powering the disclosed system with the daytime surplus of energy as hydrogen, this energy can effectively be stored for use during the night by powering an electrical generator.

For use as a sustainable source of electricity production and time-shifting, it is critical that the disclosed system be as efficient as possible. The higher the efficiency, the system can be smaller and cost less to produce and operate. As would be understood by one of skill in the art, efficiency can be calculated by (Tₘₐₓ−Tₘᵢₙ)/Tₘₐₓ, where Tₘₐₓ is the maximum cylinder temperature in degrees Kelvin and Tₘᵢₙ is the minimum temperature (in Kelvin). For example, if the maximum cylinder temperature is 1500 degrees Fahrenheit (1089 K) and the exhaust is 750 degrees Fahrenheit (672 K) then the efficiency is (1089−672)/1089 or 38.3%. 38.3% would be very good for an internal combustion engine, and has rarely been achieved with hydrogen as a fuel.

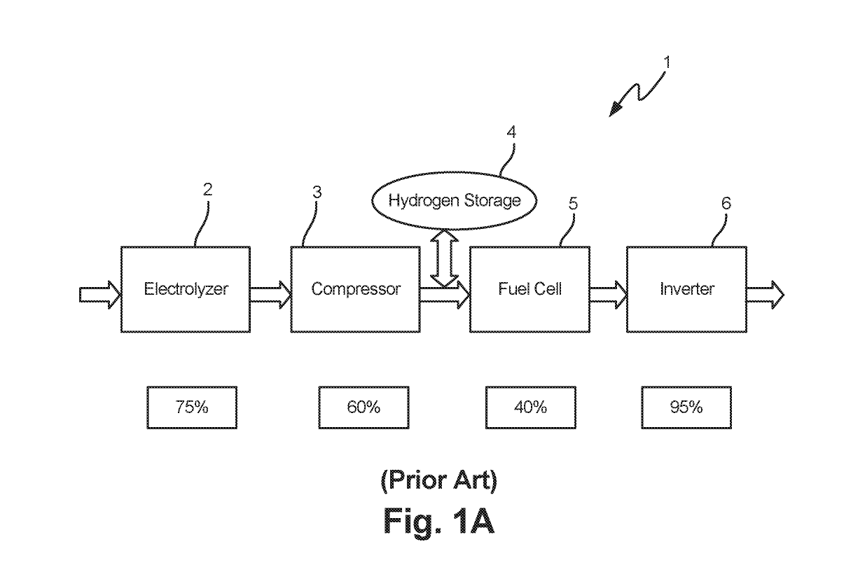

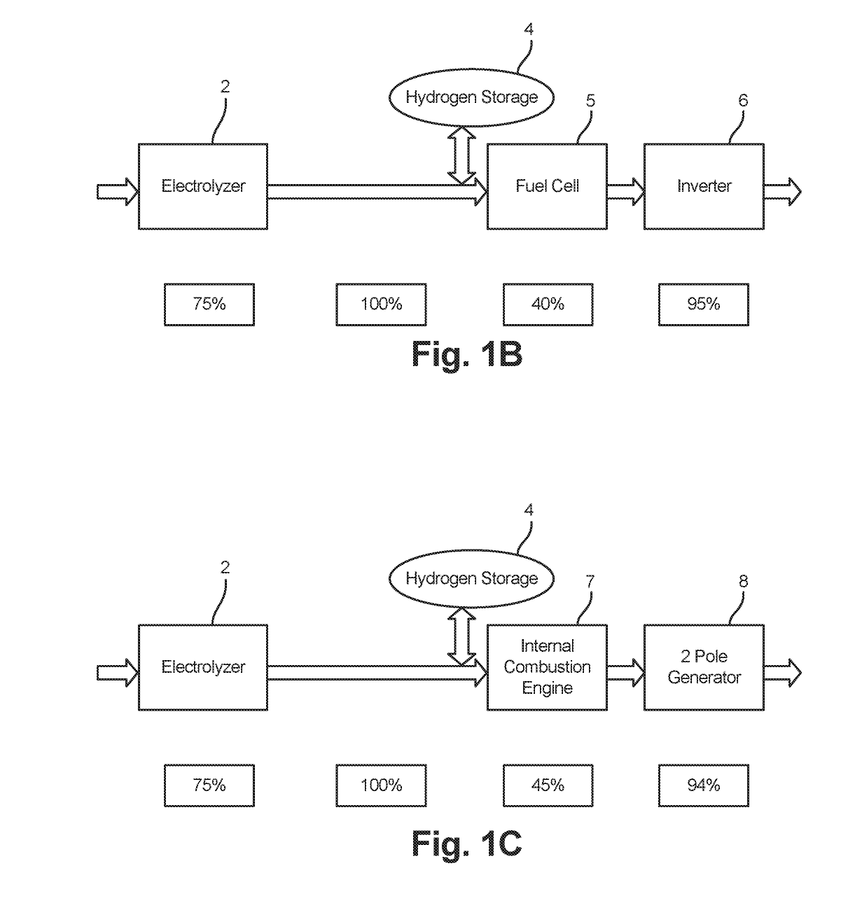

Turning to the figures in greater detail, as best shown in FIG. 1A, in a prior art hydrogen system 1, water is fed into an electrolyzer 2, where it is converted to hydrogen and oxygen. In various implementations, the electrolyzer 2 can be of the sort described in U.S. application Ser. No. 14/443,174, and Spanish Patent No. 200900163, entitled “Generador de Hidrógeno” which are hereby incorporated by reference in their entirety.

Continuing with FIG. 1A, in certain implementations after being discharged by the electrolyzer 2, the hydrogen (H) can be fed into a compressor 3 for storage 4 and/or use in a fuel cell 5, which can power an inverter 6. The approximate efficiencies of each of these components—an electrolyzer can be about 75% efficient, a compressor is about 60% efficient, a fuel cell is about 40% efficient and an inverter is about 95% efficient—equate to an overall system which is about 17.1% efficient. It is understood that a system with 17.1% efficiency provides a poor option for energy storage.

As shown in FIG. 1B, in alternate implementations without a compressor, it is possible to increase the efficiency of the overall system by removing the compressor 3 and directly routing the electrolyzer 2 into the storage 4 and/or fuel cell 5, thereby increasing the efficiency to about 28.5%. The removal of compressor 3 can be achieved by using an electrolyzer that produces hydrogen at pressure for storage 4. As shown in FIG. 1C, by replacing the fuel cell 5 and inverter 6 with a hydrogen internal combustion engine 7 and generator 8, it is possible to increase the efficiency further, to about 31.7%. In the presently disclosed system, the ability to re-circulate the water in a closed loop can provide significant further improvements in efficiency, as is described herein.

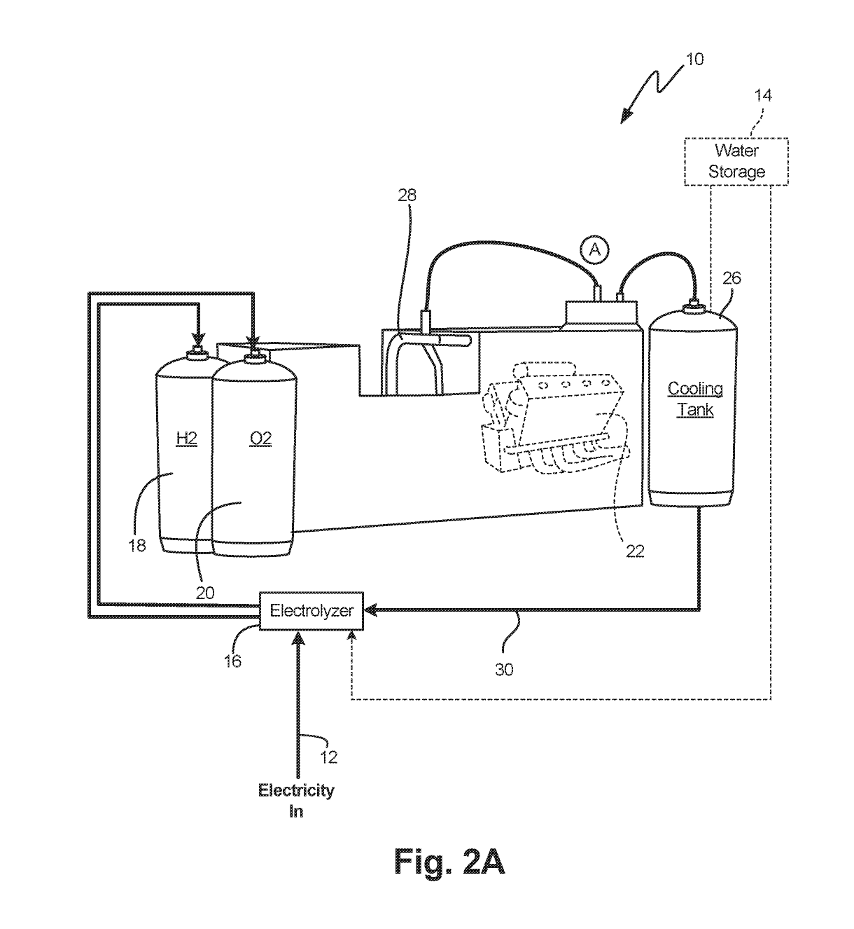

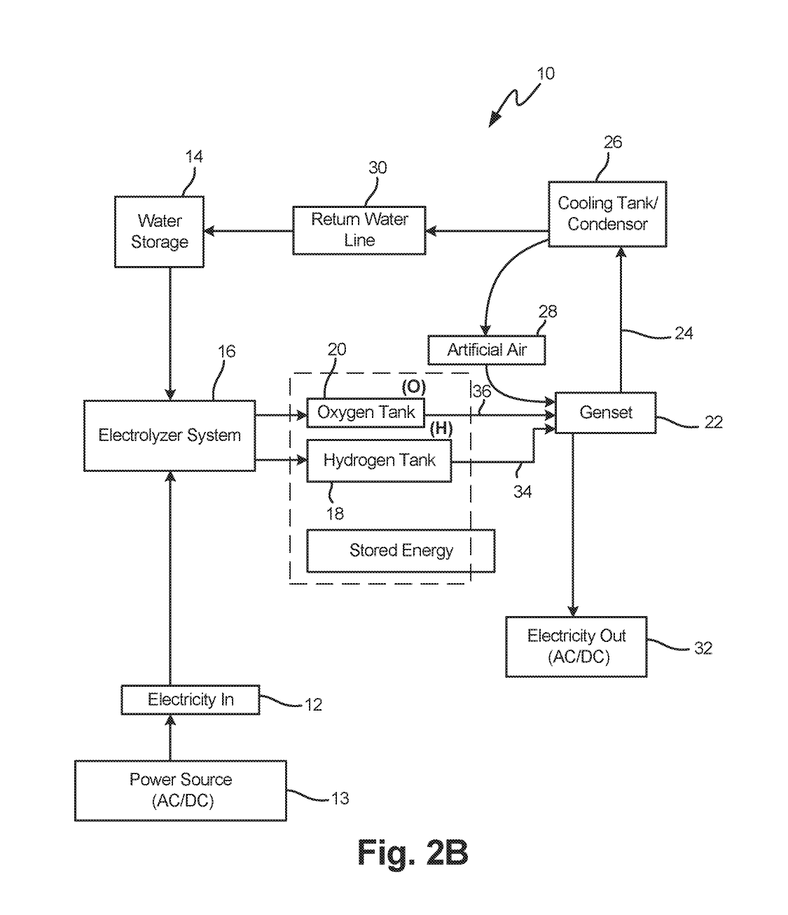

Turning to the presently disclosed technology, in FIGS. 2A-B, a closed-loop generator system, or “closed loop” 10 is provided. Exemplary embodiments of the closed loop 10 comprise an input electrical source 12 derived from a power source 13, a water storage tank 14 and an electrolyzer 16. It is understood that the input electrical source can comprise solar, hydro-electric, geo-thermal, wind and the like.

In various embodiments of the closed loop system, and as shown in FIG. 2A, the electrolyzer 16 is in sealed fluidic and gaseous communication with both a hydrogen storage tank 18 and an oxygen storage tank 20, and operates so as to produce hydrogen (H) and oxygen (O) from the water (H₂O) based on the process of electrolysis for storage in the hydrogen storage tank 18 and oxygen storage tank 20. This is depicted further in reference to FIG. 2B.

These embodiments can use a hydrogen-fueled genset 22 or other component configured to generate electrical power by way of an internal combustion engine running on hydrogen. Hydrogen-based generators typically contain a genset, and they are known in the art. Most commonly, a genset consists of a motor, typically an ICE, linked to an electrical generator, such that the mechanical power generated by the motor is transformed into electrical power by the generator. Gensets are frequently found in industrial, residential, commercial, maritime and other environments where there is a need to generate electricity. These gensets can also be useful to produce electricity when needed. They can also be used on demand. The genset would normally have an air intake and an exhaust. Thus, the system would require electricity, water, and air inputs and produces electricity and exhaust gases. In contrast, because the closed loop 10 disclosed herein requires only electricity and outputs only electricity with no need for outside water or air, and without any exhaust gas, the closed loop 10 does not have the same limitations that are typical to gensets and well-understood in the art.

In certain implementations of the closed loop 10, electrical power which is produced variably and passively, such as by wind or solar power, can be stored as hydrogen within the system in the hydrogen storage tank 18. This stored hydrogen can then be used on demand to power the genset 22 when additional electricity is required. For example, in an environment where solar power provides the bulk of the daytime electricity, excess energy produced by the solar powered system can be stored in the closed loop as hydrogen for use at night. Accordingly, in these implementations, initial electrical power is used to power the electrolyzer 16 and stored as hydrogen in the hydrogen storage tank 18 for later use.

It is important to note that HICEs produce only about 40-45% of the energy as a comparable gasoline-powered ICE. Accordingly, the conversion of an ICE to run on hydrogen (which is a lower energy density fuel base as compared to fossil fuels) generally requires more fuel to reach the same levels of power. Further, running at lean equivalence ratios (as discussed below) can also cause reductions in power. Therefore, in order to attain a similar power output, traditional ICEs converted into HICEs frequently require often modification. In certain implementations, the compression can be increased. HICEs are also frequently super-charged and/or turbo-charged to supply the additional fuel. It would be apparent to one of skill in the art that certain modifications are therefore necessary.

Returning to FIG. 2, various embodiments can further comprise an exhaust component 24, an exhaust gas cooling and water separation tank 26 or condenser, an artificial air intake system 28, a return water line 30, and an electrical power output 32. The closed loop 10 uses electricity to power the electrolyzer 16, which produces hydrogen and oxygen, which are then used to power the genset 22. The resulting combustion produces electricity, as well as water and exhaust gas. The water and exhaust gas then being returned to the beginning of the closed loop so as to be re-used again in a subsequent cycle. It is important to note that this recycling of oxygen does not require the introduction of new oxygen into the system. As the world's supply of oxygen is steadily decreasing, there are inherent advantages to oxygen-neutral applications such as these.

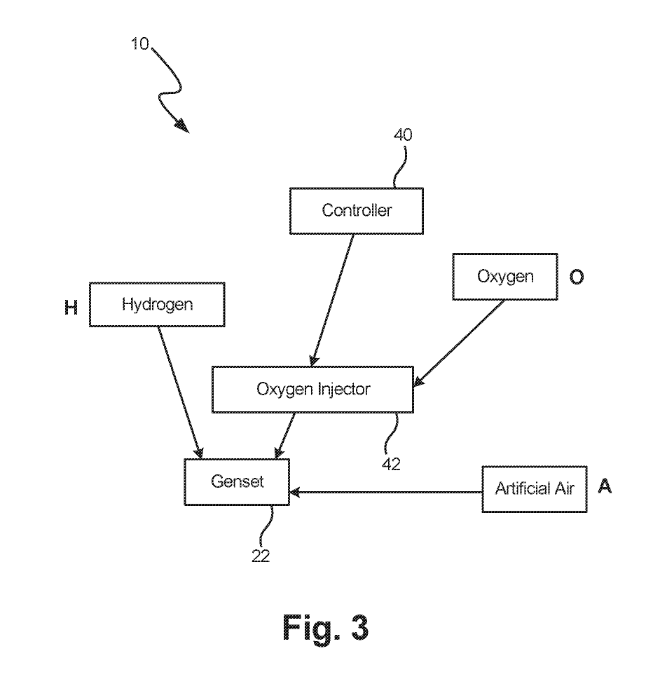

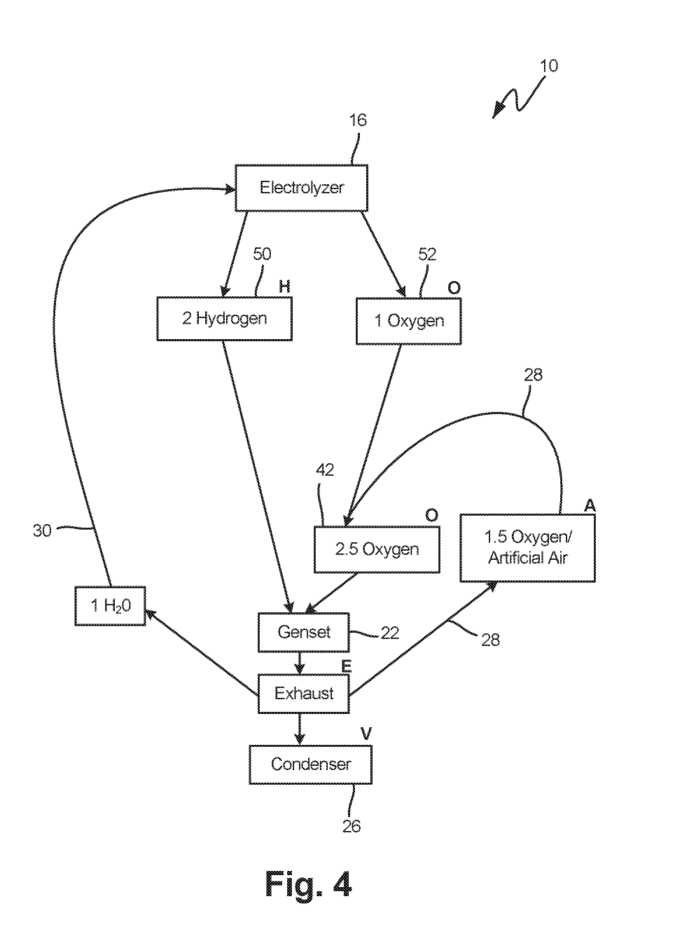

As is shown in FIGS. 3-4, exemplary embodiments of the closed loop 10 genset 22 provide a multiple fuel injection-type system where the oxygen (O) is handled like a fuel in the cylinder, such that internal combustion of the hydrogen/oxygen/artificial air is performed in the genset 22, exhausting water vapor (V) and artificial air (A), which is accordingly recycled around in a closed loop 10. The water vapor is reduced to water in the cooling tank 26, and returned to the electrolyzer 16 by the return water line 30. Further discussion of the artificial air is found below. In such a system, there is a controller 40 which is configured to monitor engine performance in the genset 22 in a manner similar to a standard electronic fuel injection (“EFI”) controller. In certain implementations, the controller 40 is configured such that the oxygen injector portion 42 of the controller 40 is able to adjust the amount of oxygen O being supplied to the cylinders, in the manner similar to the action of a supercharger. This allows the user to operate the genset at a constant-intake EQR and increase the power output from the genset 22 as desired.

One issue that has frequently plagued HICE systems has been the emission of NOx (mono-nitrogen oxides such as NO and NO₂) as a byproduct. When the exact compositions of the fuel and oxidant are known, it is possible to calculate the exact ratio of gas to fuel required to achieve combustion. In theory, the combustion of hydrogen and oxygen produces only water as a byproduct:

2H₂+O₂→H₂O+heat (1)

Because there is no carbon in the system, none is emitted when it is combusted, the creation and emission of greenhouse gases such as carbon dioxide and carbon monoxide can in theory be eliminated in HICE systems. In one liter of water, there is approximately 1.3 m³ of hydrogen and 0.6 m³ of oxygen. 1 m³ of hydrogen can produce approximately 3 kW.

However, existing ICEs and HICEs have typically used atmospheric air to provide them with the necessary oxygen (O). Atmospheric air consists of approximately 21% oxygen, and about 79% nitrogen. As a result, NOx emissions are often produced by HICEs. However, with the inclusion of atmospheric Nitrogen into the combustion, and as temperatures increase, NOx is produced as is shown in Equation 2:

H₂+O₂+N₂ [symbol] H₂O+N₂+NOx (2)

Therefore, when using atmospheric air, NOx emissions persist, despite the reduction in carbon emissions. NOx production can be on the magnitude of 10s to 1000s of parts per million. Further, as the closed loop system recirculates the emissions, the presence of NOx in the exhaust could serve to eventually saturate the system and therefore cause it to cease to function, such that the water would need to be replenished. Some of this effect can be countered by using a “lean burn” (discussed below in relation to Eq. 3), though not eliminated.

To address the creation of NOx in the closed loop, exemplary embodiments of the make use of an inert artificial air (A) in the closed gas system in place of nitrogen. In these embodiments, the artificial air can consist of argon, helium or any other inert gas which is known. Returning to FIG. 2, exemplary embodiments can further comprise an artificial air intake system 28 which is in hermetic communication with the genset 22 so as to provide the genset with additional gas to fill the cylinder and also with the water separation tank 26 or condenser so as to separate and recycle the artificial air back into the closed loop 10. The closed loop 10 uses electricity to power the electrolyzer 16, which produces hydrogen and oxygen, which are then used to power the genset 22. The resulting combustion produces electricity, as well as water and exhaust gas. The water and exhaust gas then being returned to the beginning of the closed loop so as to be re-used again in a subsequent cycle.

In exemplary embodiments, hydrogen and oxygen are thereby drawn from the storage tanks 18, 20 by way of intake lines 34, 36 into the genset, along with artificial air (A) in a proportion defined by the user, so as to produce a given quantity of electricity for output 32. Further, the exhaust (E) is pumped into the cooling and water separation tank 26 so as to be cooled, and the individual components returned to the water storage tank 14 and artificial air intake system 28, as would be apparent to one of skill in the art. In certain embodiments, the artificial air system 28 is in direct hermetic and fluidic communication with the cooling and water separation tank 26

Exemplary embodiments can therefore utilize the artificial air (A) as a means of biasing the running equivalence ratio, which is a comparison of the fuel to oxidant mixture. Equivalence ratio (“EQR”) is represented in a non-dimensional variable (Φ).

In Equation 3, the EQR (Φ) is given by:

$$Φ = \frac{{( A / F )}_{s}}{{( A / F )}_{a}} \qquad ( 3 )$$

where F=the number of moles of fuel, A=the number of moles of air, and a=actual, and s=stoichiometric, meaning that the number of moles of fuel and gas are equal. This ratio is calculated on both mass and molar basis. This therefore represents the actual fuel-to-oxidant ratio normalized by the stoichiometric fuel-to-oxidant ratio. A stoichiometric reaction is one in which all the reactants are consumed. Accordingly, a Φ=1 is called “stoichiometric,” while EQRs where Φ<1 are considered “lean” because an excess of oxidant is present, and “rich” at EQRs where Φ>1, as excess fuel is present. It is important to note that so-called “lean burn” is preferred in most HICE applications, and, as described further herein, this results in an excess of noncombusted oxygen passing through the system.

It is theoretically possible to increase the power output of the genset 22 by nearly five (5) times if 100% oxygen were used and the fuel intake could be increased accordingly. By way of example, if the genset 22 is set to operate at an equivalence ratio of 1 at 100 hp, an increase in the oxygen content from 21% to 42% and a corresponding doubling of the fuel intake would serve to approximately double the output power. However, the power level must be variable for the genset to function properly. To address this, exemplary embodiments of the closed loop introduce a re-circulating, preferably inert gas A to fill the remainder of the volume introduced into the genset, such that the intake quantities can be controlled and otherwise adjusted as needed.

### Example

### Vehicle Application

To establish that the use of inert artificial air was viable, in one example a modified 1988 Ford F-150 pickup truck with a 4.9 L inline EFI engine was run on hydrogen with a second set of injectors to provide oxygen and artificial air. The truck was equipped with hydrogen and oxygen bottles. Two controllers were used in a master-slave arrangement. It also had a closed loop artificial air supply that consisted of argon and oxygen with two associated cooling tanks. In this example, the oxygen injection system was used and increased hydrogen injection to raise the power output from the engine up to the gasoline equivalent (110 hp).

The injection of additional oxygen and hydrogen need not affect the artificial air bias point, as the oxygen and hydrogen are being injected in a stoiciometric ratio. In addition oxygen/hydrogen controls can be used to increase the power output from the engine for passing and for pulling heavily laden loads, such as towing a trailer or boat. When operated under normal highway conditions at lower power levels, the oxygen injection system was inactive and the system ran on hydrogen and artificial air. No NOx emissions were generated.

It should be noted that the use of artificial air would normally cause the engine to have a widely variable EQR, and therefore not function properly over a very wide range of power levels. To compensate, the closed-loop system introduces oxygen (O₂) into the artificial air (A) itself. This additional oxygen biases the artificial air (A) so as to allow the engine to run at any EQR selected by the user while allowing the electrolyzer to operate at a stoichiometric ratio. This possible difference in these ratios is crucial to the operation of the closed loop 10. Further, the use of oxygen can increase the power output of the HICE.

As would be apparent to one of skill in the art, and as shown in FIG. 4, the electrolyzer 16 produces hydrogen and oxygen at a stoichiometric ratio (2:1). However, for a variety of reasons, it is undesirable to run an HICE genset 22 at that ratio. Instead, HICEs can and should be run very lean at an equivalence ratio of 0.43 or less. The equivalence ratio is the ratio of air to fuel compared to the stoichiometric ratio. For example, to run at an EQR of 0.4, as opposed to stoichiometric, two and a half times more oxygen is actually required ((2H/2.5O)/(2H/1O)=0.4). Extended out to include the composition of atmospheric air, HICEs require running at about a 0.4 EQR to a achieve <10 ppm NO emissions when using atmospheric air. Thus, when using artificial air, no NOx is produced at all.

Because the combustion of hydrogen dictates the amount of water (H₂O) produced, and therefore oxygen consumed, the excess oxygen can remain in the system and be collected and re-circulated. This also applies to artificial air (A), which can be separated from the water vapor at the water separation tank 26 or condenser and redirected into the genset 22, as is shown in FIGS. 2 and 4.

FIG. 4 further depicts the movement of the relative quantities of hydrogen (H), oxygen (O), and artificial air through the closed loop when the EQR is set to 0.4. The electrolyzer 16 produces two molecules of hydrogen and 1 molecule of oxygen (blocks 50 and 52). The oxygen is then biased by the artificial air and an additional 1.5 molecules of oxygen which are present in the closed loop 10, before being introduced into the genset 22. Following combustion, the excess oxygen and artificial air can be separated from the exhaust, such that the water is returned to the electrolyzer and the additional air (A and O), can be recycled into the genset 22.

It is important to note that in these implementations, the gases inside the closed loop 10 are humid, meaning that water vapor is traveling through the combustion cycle at all times. In practice, when the genset is operating and both the intake and exhaust are open, the genset 22 has an overlap on the cams, the air is being run across the top of the cylinder, and the genset 22 is pulling a vacuum on the artificial air intake system 28. This vacuum is in gaseous communication with the water separation tank 26 or condenser, such that the saturated oxygen/artificial air gases are constantly circulating through the system, such that condensation is occurring constantly, such that water is simultaneously being generated by the genset 22, being transmitted back to the water storage tank 14, and circulating through the artificial air intake system 28 as water vapor, along with the additional biasing oxygen (O).

Therefore, in the closed loop 10, there are two distinct ratios being utilized: the ratio of hydrogen to oxygen produced by the electrolyzer, and the ratio of oxygen being drawn into the genset. Because the genset 22 theoretically can only utilize the amount of oxygen supplied by the electrolyzer 16 to fully oxidize the provided hydrogen, it is important that in exemplary embodiments additional oxygen must travel through the closed loop 10 without being combusted by way of the artificial air intake system 28.

Further, as the amount of hydrogen and oxygen increase in the HICE, the amount of artificial air decreases. The reduction of artificial air causes the efficiency of the system to increase because less artificial air needs to be heated in the combustion chamber and thus fewer BTUs are lost in the exhaust stream. One of skill in the art can therefore calibrate the closed loop system accordingly.

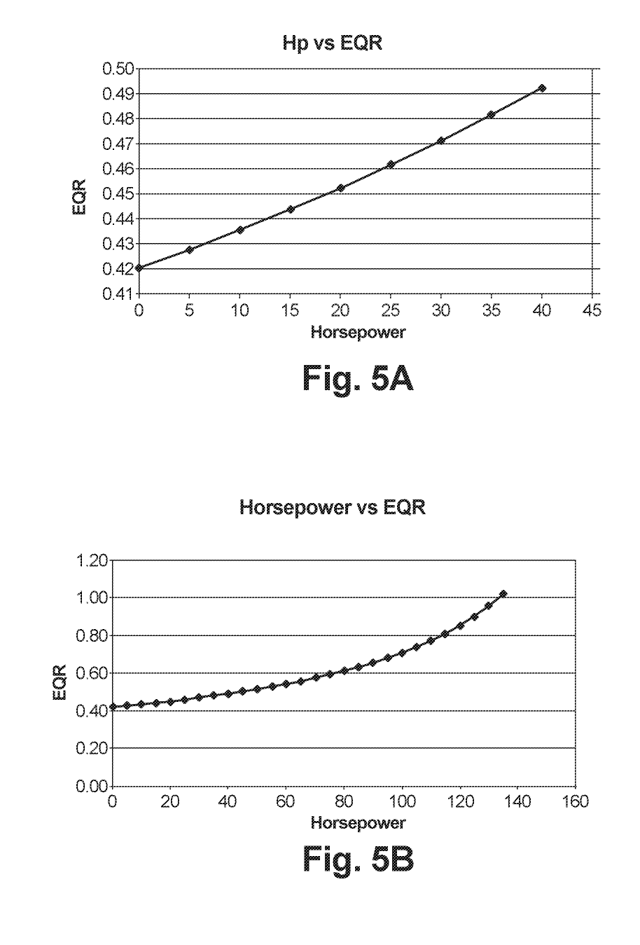

By way of example, the closed loop 10 genset 22 can operate at an EQR of 0.4 (or any other) to produce variable power and yet operate the electrolyzer at a stoichiometric ratio. Table 1 depicts the actual EQRs and gas concentrations at various horsepower, given an initial EQR of 0.4, given 3600 rpms on a 100 cubic inch 2-cylinder engine with 20.7% air. As an example, FIGS. 5A-B depicts the relationship between power output in HP and EQR. Accordingly, by using an inert gas in the artificial air and additional oxygen, a portion of oxygen is not consumed, and therefore following the initial biasing of the closed loop, the initial bias point can be held for long periods of time. Further, the bias point can be increased or decreased at any time without affecting the electrolyzer or the associated gas storage systems discussed above in relation to FIG. 2.

In various embodiments, the hydrogen is used as fuel and the oxygen is used to increase the power output (as is also demonstrated in Table 1). The genset engine controls require that hydrogen and oxygen are available at all times. In these embodiments, it is possible to increase the power output from an HICE without having to add a super-charger or turbo-charger. For example, Ford Power Products and Ballard developed a 6.8 L V10 Ford engine powered genset that produced 140 kW. The engine was turbo-charged. Higher power output levels, like 250 kW, were sought, but not achieved. With the disclosed closed loop, it is possible to achieve 250 kW from a non-turbo charged engine by increasing the oxygen and hydrogen intake, as has been previously established. Other configurations of the genset are possible, as would be apparent to one of skill in the art.

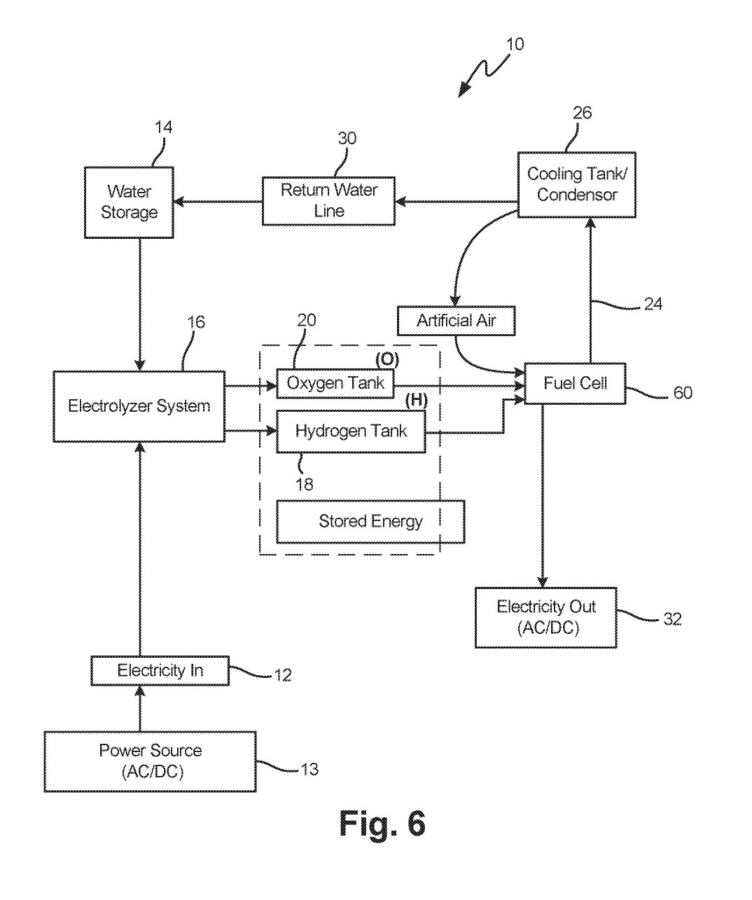

In an alternative embodiment of the closed loop 10 shown in FIG. 6, a fuel cell 60 may be substituted for the genset. In these embodiments, the closed loop 10 again comprises an input electrical source 12 derived from a power source 13, a water storage tank 14 and an electrolyzer 16. In these embodiments, the electrolyzer 16 is in sealed fluidic and gaseous communication with both a hydrogen storage tank 18 and an oxygen storage tank 20, and operates so as to produce hydrogen (H) and oxygen (O) from the water (H₂O) based on the process of electrolysis for storage in the hydrogen storage tank 18 and oxygen storage tank 20. These embodiments further comprise an exhaust component 24, an exhaust gas cooling and water separation tank 26 or condenser (though this is not necessary in all embodiments, as the fuel cell 60 will primarily produce water), a return water line 30, and an electrical power output 32. Notably, an artificial air intake system 28 is not required in these embodiments, as a fuel cell 60 will always run at a stoichiometric EQR. Therefore, the closed loop 10 in this embodiment operates simply as an energy storage device, such that a user may dictate the time of use, as discussed above.

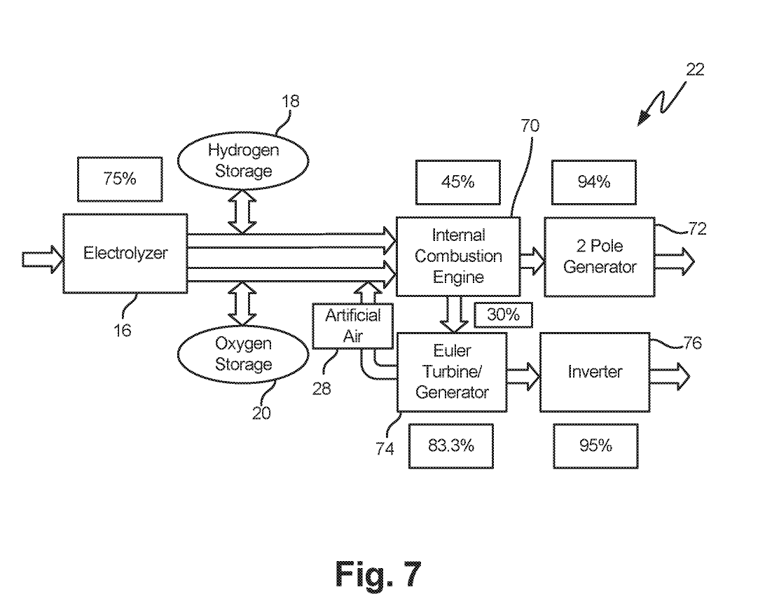

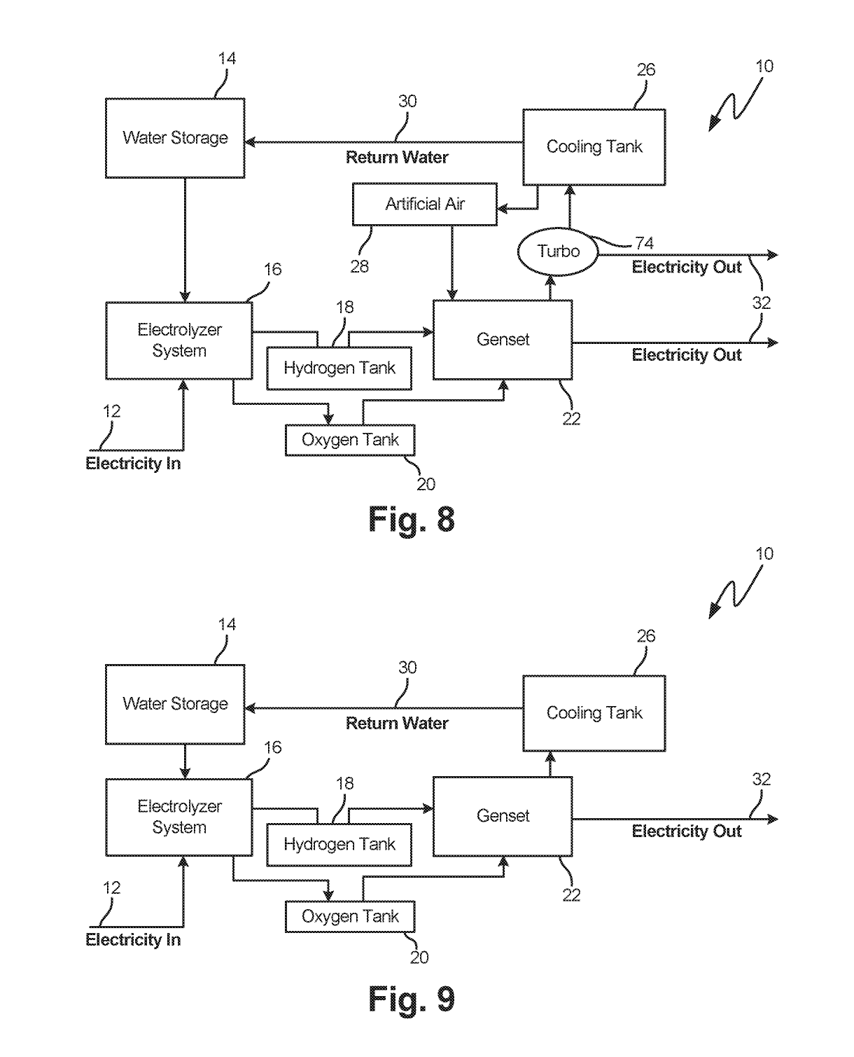

As shown in FIGS. 7-8, in certain implementations, the genset 22 internal combustion engine 70 is in operable communication with a generator 72, such as a two pole generator, as well as a turbo or turbine/generator 74, such as a Euler turbine/generator. In these implementations, the turbo or turbine/generator 74 can be used to turn a high speed generator with the high temperature exhaust steam of the engine. The turbine therefore reduces the temperature of the exhaust steam, condensing it to water and gases that can be circulated back to the electrolyzer 16 and internal combustion engine 70, and can produce additional energy which can be run through an inverter 76, to produce additional electricity, thereby providing about 57% or more efficiency. as would be apparent to one of skill in the art, the use of the turbo or turbine/generator 74 also simplifies the condensing of water and produces additional electricity 32.

In further examples of the system 10 utilizing a turbo or turbine/generator 74, it is possible to achieve a maximum cylinder temperature is 1500 degrees Fahrenheit (1089 K) where the exhaust is 300 degrees Fahrenheit (422 K), thereby resulting in a (Tₘₐₓ−Tₘᵢₙ)/Tₘₐₓ efficiency of (1089−422)/1089 or 61.2% —higher than has ever achieved with an internal combustion engine. As shown in FIG. 9, in certain implementations, the system 10 can operate without a turbine/generator.

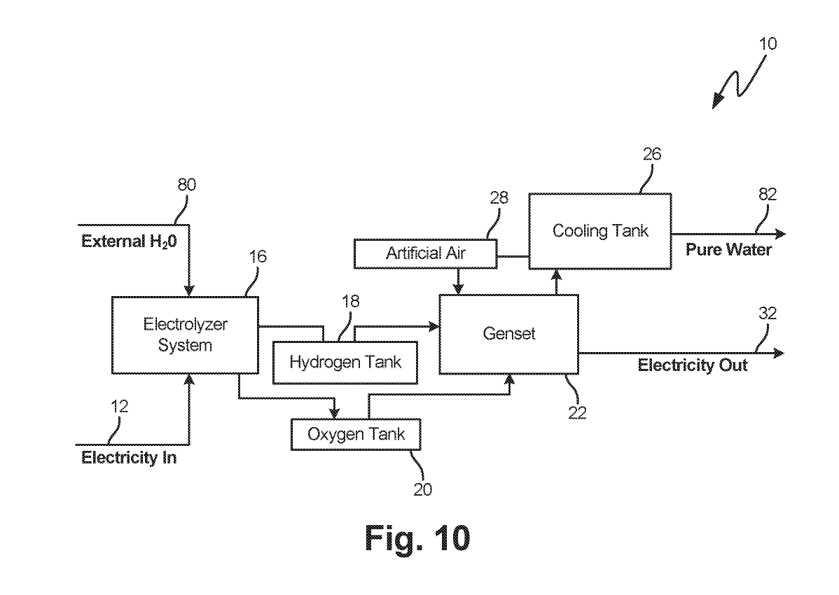

In FIG. 10, in certain circumstances, such as for medical applications, there is a need for pure water. In certain implementations, the system 10 can be operated to recover water for use. In these implementations, rather than utilizing a water storage tank and return water line (discussed above), the system 10 draws external water 80, which is super-heated as it passes through the system 10, such that the condensation in the cooling tank 26 can be drawn as pure water. In alternative implementations, the water is returned to the system as described above, and electrolyzer water can be drawn as pure water 82. In either case, certain medical and other public health applications, particularly in impoverished regions, often require pure water. It is understood that in these implementations, water drawn from the genset 22 is “new,” pure water 82 and “created” at high temperature, such that it does not contain any viruses or bacteria.

The closed loop 10 thus provides a self-fueled generator system which does not require additional air or water input. It is unaffected by altitude changes and can operate underwater. In essence, it behaves like a battery that can take in one type of input voltage and output the same or a different voltage. In certain embodiments, the storage of electrical energy can be extremely long. It therefore provides a system for the capture and storage of intermittent energy.

Although the disclosure has been described with reference to preferred embodiments, persons skilled in the art will recognize that changes may be made in form and detail without departing from the spirit and scope of the disclosed apparatus, systems and methods.

What is claimed is:

1. A closed loop generator system, comprising:
a) an electrolyzer comprising a water supply and configured to produce hydrogen and oxygen;
b) a hydrogen tank;
c) an oxygen tank;
d) a closed air supply; and
e) a genset configured to run on stored hydrogen and oxygen to convert stored hydrogen and oxygen into water fed into the water supply,
wherein the closed loop generator system is configured so as not to produce exhaust.

2. The closed loop system of claim 1, further comprising an artificial air system in hermetic communication with the genset.

3. The closed loop system of claim 2, wherein the artificial air system is configured to bias the genset to run lean.

4. The closed loop system of claim 2, wherein the artificial air system is configured to bias the genset to run at an equivalence ratio of less than 0.43.

5. The closed loop system of claim 1, wherein the closed loop generator system is fluidically and hermetically sealed.

6. The closed loop system of claim 1, further comprising a water storage unit.

7. The closed loop system of claim 1, further comprising a turbine in operational communication with the genset, the turbine being configured to increase system efficiency.

8. A closed loop generator system, comprising:
a) an electrolyzer comprising a water supply;
b) a hydrogen storage tank;
c) an energy source in operational communication with the electrolyzer and hydrogen storage tank; and
d) an electrical current generator,
wherein the closed loop generator system is configured to selectively operable to generate output electricity without emissions.

9. The closed loop generator system of claim 8, wherein the electrical current generator is selected from the group consisting of a genset and a fuel cell.

10. The closed loop generator system of claim 8, wherein the energy source is a renewable source of electricity.

11. The closed loop generator system of claim 11, wherein renewable source of electricity is selected from the group consisting of solar power, wind power and hydro-electric power.

12. The closed loop generator system of claim 8, wherein the system is configured to time-shift energy production.

13. The closed loop generator system of claim 8, wherein the electrical current generator is a genset configured to be powered by hydrogen and oxygen.

14. The closed loop generator system of claim 13, further comprising an artificial air system configured to bias the genset oxygen supply.

15. The closed loop generator system of claim 14, further comprising an oxygen injector and controller.

16. The closed loop generator system of claim 8, wherein the water supply is in sealed hermetic and fluidic communication with the genset such that water vapor exiting the genset is fed into the electrolyzer.

17. The closed loop generator system of claim 16, further comprising an oxygen storage tank, wherein:
a) the electrolyzer and electrical current generator are configured to be independently operable, and
b) the hydrogen storage tank and oxygen storage tank are in sealed hermetic and fluidic communication with the electrolyzer and electrical current generator so as to be configured to store hydrogen and oxygen from the electrolyzer for selective use by the electrical current generator.

18. A method of time-shifting energy production, comprising:
a) providing a renewable energy source of electricity;
b) providing a closed loop generator, the generator comprising:
I. an electrolyzer comprising a water supply;
II. a genset,
III. a hydrogen storage tank in sealed fluidic and hermetic communication with the electrolyzer and genset; and
IV. an oxygen storage tank in sealed fluidic and hermetic communication with the electrolyzer and genset, wherein:
A) the electrolyzer and genset are configured to be independently operable, and
B) the hydrogen storage tank and oxygen storage tank are in sealed hermetic and fludic communication with the electrolyzer and genset so as to be configured to store hydrogen and oxygen from the electrolyzer for selective use by the genset; and
c) supplying the hydrogen and oxygen storage tanks by selectively operating the electrolyzer by way of the renewable source of electricity.

19. The method of time-shifting energy production of claim 18, wherein the water supply is in sealed hermetic and fluidic communication with the genset such that water vapor exiting the genset is the water supply.

20. The method of time-shifting energy production of claim 18, further comprising providing a euler turbine to increase efficiency.
